(19) United States
(12) Patent Application Publication
(10) Pub. No.: US 2006/0258875 A1
(43) Pub. Date: Nov. 16, 2006

(54) Methods for manufacturing supported nanocatalysts and methods for using supported nanocatalysts

(76) Inventors: Clementine Reyes, Lawrenceville, NJ (US); Sukesh Parasher, Lawrenceville, NJ (US); Bing Zhou, Cranbury, NJ (US)

Correspondence Address: John M. Guynn;WORKMAN NYDEGGER, 1000 Eagle Gate Tower, 60 East South Temple, Salt Lake City, UT, 84111, US

(21) Appl. No.: 11/126,963

(22) Filed: May 10, 2005

(51) Int. Cl. B01J 21/18; B01J 31/00; B01J 29/04; B01J 21/16

(52) U.S. Cl. 558/357; 502/60; 502/80; 502/159; 502/180; 502/182; 502/185; 502/150; 562/45; 562/493; 585/422; 556/136; 977/896

(57) ABSTRACT

Supported nanocatalysts are manufactured by reacting a functionalized support with a plurality of catalyst atoms in the presence of a solvent. Available functional groups on the support material bind to the catalyst atoms and influence nanoparticle formation and/or nanoparticle anchoring. The functionalized support can be manufactured from a support material and a functionalizing agent that has at least two functional groups for bonding individual functionalizing agent molecules both to the support and to the catalyst atoms. Supported palladium nanocatalysts manufactured using the methods of the present invention are particularly useful for performing Heck and Suzuki carbon-carbon coupling reactions.

### BACKGROUND OF THE INVENTION

1. The Field of the Invention

The present invention relates generally to supported nanocatalysts and methods for making and using such catalysts. The nanocatalyst particles are manufactured by reacting a plurality of catalyst atoms with a functionalized support. The novel supported nanocatalysts can be used in a variety of reactions, including Heck and Suzuki carbon-carbon coupling reactions.

2. The Related Technology

Catalysts are widely used in many industrial applications such as refining and fine chemicals manufacturing. The catalyst is often a crucial aspect of a chemical reaction. In some cases, the catalyst is necessary for a reaction to occur. In other cases, the catalyst is necessary for the process to be economically viable.

Catalysts are typically expensive for a variety of reasons. Some catalysts are expensive because they are made from precious metals, such as platinum or palladium. Other catalysts are expensive because of the processing that is required to obtain a catalyst with a particular size, shape, or crystal phase. Because of the high costs of catalysts, even small improvements in catalyst performance can significantly affect the overall cost of a chemical process.

In addition to improving catalyst performance, one way of reducing the cost of a catalyst is to reuse the catalyst. Theoretically a catalyst is not consumed in a reaction and therefore could be used indefinitely in a particular chemical process. In practice, however, catalysts are often consumed or destroyed during use through mechanisms such as catalyst leaching, attrition, or deactivation. In some cases, the catalyst is lost in the product solution. The need to provide very small catalyst particles contributes to the difficulties of catalyst recovery.

For example, certain pharmaceutical reactions, such as the Heck or Suzuki reactions, utilize expensive homogeneous precious metal catalysts, such as palladium and platinum. The inability to economically recover such homogeneous precious metal catalysts greatly increases the cost of such reactions.

Therefore, what are needed are new methods of manufacturing useful catalysts that provide the ability to more easily recover such catalysts and/or which increase catalytic activity.

### BRIEF SUMMARY OF THE INVENTION

The present invention provides novel methods for making supported nanocatalysts. The catalysts of the present invention are manufactured using a functionalized support. The functionalized support is reacted with a plurality of catalyst atoms to form supported nanocatalyst particles.

The functionalized supports used to form the nanocatalyst particles of the present invention comprise a plurality of functionalizing molecules bonded to a support material. The functionalizing molecules have at least one functional group available for bonding with the catalyst atoms and to form the nanocatalyst. Nanocatalyst particles are formed by reacting a solution of catalyst atoms with the functionalizing molecules on the support. In one aspect, the functional groups on the functionalizing molecules influence the formation of the catalyst nanoparticles. In another aspect, they may act to anchor the nanocatalyst particles to the support material.

The functionalized support can include any solid support material known to those skilled in the art for supporting catalyst nanoparticles. Suitable support materials include inorganic supports, such as silica, alumina, and other metal oxides, and carbon-based supports, such as activated carbon, carbon black and polymers.

The functionalizing molecules are organic compounds that have at least one functional group available for bonding to catalyst atoms. The functional group can be any functional group capable of bonding or interacting with the catalyst atoms. Suitable functional groups include hydroxyl groups, carboxyl groups, carbonyl groups, amine groups, thiol groups, sulfonic acid groups, sulfonyl halide groups, acyl halide groups, combinations of these, and derivatives of these.

The nanocatalyst particles of the present invention can be made using a variety of different catalytic materials, including noble metals, base transition metals, rare earth metals, and nonmetals. During formation of the nanocatalyst particles of the present invention, the functionalizing molecules influence the arrangement and/or bonding of the catalyst atoms. Because the functionalizing molecules are bonded to the support material, the functionalizing molecules influence nanoparticle formation in a particular way. In addition, functionalizing molecules may influence catalytic properties because of the way the particles are bonded to the support material during or after particle formation. Regardless of the theoretical cause of the unique and/or improved catalytic properties, the method of the present invention are advantageous because they provide novel and/or improved catalysts as evidenced by the differences in catalytic properties as compared with known catalysts.

According to one embodiment, the functionalized support is manufactured from a support material and a functionalizing agent. The functionalizing agent includes individual functionalizing molecules, each having at least two functional groups: a first functional group that serves to bond the functionalizing agent molecules to the support material, and a second functional group that remains available for bonding to the catalyst atoms. In this embodiment, a functionalized support is manufactured by reacting the functionalizing agent with the support material, yielding a support material to which individual functionalizing molecules are bonded and available for subsequent reaction with one or more types of catalyst atoms.

The advantage of manufacturing the functionalized support using a functionalizing agent is that there are many different and relatively inexpensive functionalizing agents that are commercially available. The many different combinations of functionalized supports and catalyst atoms provide a large selection of catalysts that have the potential to provide a variety of different catalytic activities.

According to another aspect of the invention, supported nanocatalysts are utilized in specific reactions (e.g., Heck or Suzuki reactions used to manufacture pharmaceuticals). Preferred supported nanocatalysts used in such reactions are manufactured according to the inventive methods disclosed herein. Supported nanocatalysts overcome many of the problems associated with homogeneous catalysts known in the art, including increased ability to recover and recycle the used catalyst.

These and other advantages and features of the present invention will become more fully apparent from the following description and appended claims as set forth hereinafter.

### DETAILED DESCRIPTION OF EXEMPLARY EMBODIMENTS

I. Introduction

The present invention is directed to the manufacture of novel supported nanocatalysts. In one aspect, the nanocatalyst particles are manufactured using a functionalized support and a plurality of catalyst atoms. The functionalized support includes a functionalizing agent having available functional groups bonded to a support material. Because the available functional groups of the functionalizing agent are bonded to the support material prior to formation of the catalyst nanoparticles, they can influence particle formation and/or anchoring to produce catalyst nanoparticles with unique properties, such as improved catalytic activity.

In another aspect of the invention, supported and anchored nanocatalysts are utilized instead of homogeneous catalysts in reactions such as the Heck or Suzuki reactions in the manufacture of chemicals used in the production of pharmaceutical products. Preferred catalysts used in these reactions are made according to the inventive methods disclosed herein.

For purposes of this invention, the term “nanoparticles” or “nano-sized particles,” means particles with a diameter of less than about 100 nanometers (nm).

II. Components Used to Manufacture Supported Nanocatalysts and Intermediates

Supported catalysts according to the invention are typically manufactured using a functionalized support, one or more different types of catalyst atoms, and a solvent. As will be discussed more fully below, the catalyst atoms are reacted with the functionalized support in the presence of the solvent in order for the available functional groups on the support to complex with the catalyst atoms. The nanocatalyst particles form through the influence of the functionalized support. The nanocatalyst particles may form in solution, as the solvent evaporates, or upon further treatment such as calcining and/or reduction. At some point in the process, the influence of the functional groups creates catalyst nanoparticles with unique properties.

A. Catalyst Atoms

The catalyst atoms that form the nanocatalyst particles of the present invention can include any metal or nonmetal, alone or in combination with other elements, so long as the nanoparticles formed therefrom exhibit catalytic activity. Examples include one or more noble metals, which include platinum, palladium, iridium, gold, osmium, ruthenium, rhodium, and rhenium. Examples of other catalyst atoms include one or more base transition metals, rare earth metals, alkaline earth metals, alkali metals, or nonmetals, which can be used alone or in combination with other catalyst materials. Palladium is particularly useful for manufacturing catalysts used for carbon-carbon coupling reactions (e.g., in Heck or Suzuki reactions).

As described below, the catalyst atoms are added to an appropriate solvent or carrier to form a solution or suspension. Catalyst atoms can be added to a solution in elemental (e.g., metallic) or ionic form. Typically, the catalyst atoms are added in ionic form so as to more readily dissolve or disperse within the solvent or carrier. Examples of suitable ionic forms include metal halides, nitrates or other appropriate salts that are readily soluble in a solvent or carrier. Specific examples include metal phosphates, sulfates, tungstates, acetates, citrates, and glycolates.

Catalyst atoms that are compounds themselves, such as oxides, can be added to a liquid medium in the appropriate compound form, or may be in a different chemical form that is converted to the appropriate chemical form during catalyst formation.

B. Functionalized Supports

The component that is used to form preferred nanocatalyst particles according to the inventive methods disclosed herein are functionalized supports. The term “functionalized support” refers to any support material to which one or more types of functional groups have been attached prior to reaction or complexing with the catalyst atoms to form the nanocatalyst particles. Functionalized supports useful in the methods disclosed herein include a functionalizing agent bonded to a support material that includes available functional groups for bonding with the catalyst atoms. A more detailed discussion of functionalizing agents and support materials will now be given.

1. Functionalizing Agents and Molecules

Functionalizing agents are organic compounds that include functional groups that can be reacted with bonding sites on a support material. Once the molecules of the functionalizing agent are reacted with the support material, the functionalizing agent molecules become functionalizing molecules. The functionalizing agents include individual molecules having at least two functional groups: a first functional group capable of bonding to the support material and a second functional group capable of bonding to the catalyst atoms used to form the nanocatalyst particles. The two or more functional groups may be of the same type, or may be selected from two or more different types.

The functional groups available for bonding with the catalyst atoms are selected to promote the formation of a catalyst complex between the functionalizing agent molecules and the catalyst atoms. The functionalizing agent is selected to yield nanocatalyst particles that have a desired stability, size and/or uniformity.

Functionalizing agents within the scope of the invention include a variety of small organic molecules, as well as polymers and oligomers. Suitable functional groups for complexing with catalyst atoms include one or more of a hydroxyl, a carboxyl, carbonyl, an amine, an amide, an amino acid, a thiol, a sulfonic acid, a sulfonyl halide, an acyl halide, a nitrile, a nitrogen with a free lone pair of electrons (e.g., pyridine), combinations of these, or derivatives of these.

The functionalizing agents used to make functionalized supports can include bifunctional or polyfunctional molecules. That is, the functionalizing agent molecules include at least two available functional groups initially: one or more functional groups for bonding to the support material and one or more remaining functional groups available for bonding to the catalyst atoms. Examples of bifunctional functionalizing agents include diacids such as oxalic acid, malonic acid, maleic acid, succinnol acid, and the like; dialcohols such as ethylene glycol, propylene glycol, 1,3-propanediol, and the like; and hydroxy acids such as glycolic acid, lactic acid, and the like. Useful polyfunctional molecules include sugars such as glucose, polyfunctional carboxylic acids such as citric acid, hydroxy diacids, and the like.

Other useful functionalizing agents include ethanolamine, mercaptoethanol, 2-mercaptoacetate, amino acids such as glycine and alanine, sulfonic acids such as sulfobenzyl alcohol and sulfobenzoic acid, and other sulfobenzyl compounds having amino and thiol functional groups.

Functionalizing agents according to the invention also include polymers or oligomers, which can be natural or synthetic. In the case where the functionalizing agent is an oligomer or polymer, the molecular weight, measured in number average, is preferably in a range from about 300 to about 15,000 Daltons, more preferably in a range of about 600 to about 6000 Daltons. However, it is recognized that even high molecular weight polymers, i.e., greater than 15,000, can be used as the functionalizing agent if they are readily soluble in solvents, carriers or vehicles and can complex with the catalyst atoms.

The molecular weight of the polymer or oligomer molecules may be selected to yield functionalizing agents having a desired number of functional groups per molecule. In general, the number of functional groups may range from 4 to 200 functional groups per functionalizing agent molecule, preferably from about 8 to about 80 functional groups, and more preferably from about 10 to about 20 functional groups. In many cases, the number of functional groups within a polymer or oligomer at least approximately corresponds to the number of repeating units.

In general, it has been found that selecting shorter polymers having a lower molecular weight (e.g., less than or equal to about 20 repeating units) increases the likelihood that the functionalizing polymer will be linear or straight-chained rather than branched. Functionalizing agents having predominately straight-chained or linear molecules yield supported catalysts in which a majority (i.e., at least about 50%, preferably at least about 70%, more preferably at least about 80%, and most preferably at least about 90%) of the individual catalyst atoms of the exposed crystal face have a nearest neighbor coordination number of 2 (e.g., a 110 crystal face exposition in the case of palladium). A more detailed description of supported catalysts having a nearest neighbor coordination number of 2, though manufactured in a different manner, is set forth in U.S. application Ser. Nos. 10/618,909 and 10/618,808, both of which were filed Jul. 14, 2003 and which are incorporated by reference.

It is believed that catalyst particles in which the exposed catalyst atoms have a nearest neighbor coordination number of 2, when used in Heck or Suzuki coupling reactions, will preferentially yield linear rather than branched isomers of the desired reaction product. Therefore, when it is desired to promote linear reaction products, it will be advantageous to utilized functionalizing agents that yield catalyst particles in which a majority of the surface atoms have a nearest neighbor coordination number of 2.

Suitable polymers and oligomers within the scope of the invention include, but are not limited to, polyacrylates, polyvinylbenzoates, polyvinyl sulfate, polyvinyl sulfonates, including sulfonated styrene, polybisphenol carbonates, polybenzimidizoles, polypyridine, sulfonated polyethylene terephthalate. Other suitable polymers include polyvinyl alcohol, polyethylene glycol, polypropylene glycol, and the like.

The functionalizing agents, more particularly the functionalize supports, of the present invention allow for the formation of very small and uniform nanoparticles. In a preferred embodiment, the catalyst nanoparticles formed using functionalized agents and supports according to the invention are preferably less than about 100 nm, more preferably less than about 10 nm, even more preferably less than about 6 nm, and most preferably less than about 4 nm.

As described above, the functionalizing agent molecules include a functional group for bonding to the support surface. The functional groups described above for bonding to catalyst atoms may also be suitable for bonding the functionalizing agent to the support material. Additional functional groups suitable for bonding the functionalizing agent to a support surface include silanes and the like. Silanes are typically used to ftuctionalize silicas. The functional groups listed above for bonding to the catalyst atoms can be incorporated into a silane. The modified silane can then serve as a functionalizing agent for bonding to and functionalizing a support material. Those skilled in the art are familiar with manufacturing silanes that can provide a desired functionality.

The exemplary functionalizing agents listed above are referred to in their unbound form. Those skilled in the art will recognize that once the functionalizing agent is reacted with the support and/or the catalyst atoms, the functionalizing agent molecules change slightly, (e.g. by losing a hydrogen or hydroxyl in a condensation reaction). As used herein, the foregoing functionalizing agents and molecules includes these derivative compounds.

2. Support Materials

Any solid support material known to those skilled in the art as useful nanoparticle supports can be used to form functionalized supports which are, in turn, used to manufacture supported nanocatalysts according to inventive methods disclosed herein. Exemplary supports may be in a variety of physical forms. They may be either porous or non-porous. They may be 3-dimensional structures such as a powder, granule, tablet, extrudates, or other 3-dimensional structure. Supports may also be in the form of 2-dimensional structures such as films, membranes, coatings, or other mainly 2-dimensional structures. They may be 1-dimensional structures, such as fibers or other essentially linear structures.

In an exemplary embodiment, the support comprises an inorganic material. These include, but are not limited to, alumina, silica, silica gel, titania, kieselguhr, diatomaceous earth, bentonite, clay, zirconia, magnesia, as well as the oxides of various other metals, alone or in combination. They also include porous solids collectively known as zeolites, natural or synthetic, or other materials which have ordered or quasi-ordered pore structures.

Another useful class of supports preferred for some applications include carbon-based materials, such as carbon black, activated carbon, graphite, fluoridated carbon, and the like. Other useful classes of support materials include organic solids, such as polymers, and metals and metal alloys.

In a preferred embodiment, the support material is an inorganic material. The methods of the present invention are advantageously carried out with inorganic materials because of the beneficial properties of inorganic supports when used in many chemical processes. For example, inorganic supports are often more easily formed into shapes than organic materials. Furthermore, the methods of the present invention provide good anchoring of the nanoparticles on inorganic supports despite the fact that inorganic supports are known to have somewhat poorer adhesion for nanoparticles as compared to organic supports such as activated carbon.

The surface area of the support material will depend on the particular application and the type of material being used. In the case where porous solids are used as the support material, it is preferred that the surface area of the support be at least about 20 m²/g, and more preferably more than about 50 m²/g.

C. Catalyst Complexes

The term “catalyst complex” refers to a composition in which a bond or coordination complex is formed between one or more types of functional groups on a functionalized support and one or more different types of catalyst atoms. The “bond” between the functional groups and catalyst atoms can be ionic, covalent, electrostatic, or it can involve other bonding forces such as coordination with nonbonding electrons, Van der Waals forces, and the like.

In some cases, the catalyst complex comprises nanocatalyst particles bonded or anchored to the functionalized support. In other cases, a catalyst complex is formed initially without the formation of nanocatalyst particles as an intermediate catalyst composition. The intermediate catalyst composition is then subjected to one or more appropriate processing steps (e.g., heat treatment and/or reduction) to yield the nanocatalyst particles.

D. Solvents and Carriers

A solvent or carrier can be used as a vehicle for combining the catalyst atoms (typically in the form of an ionic salt) and the functionalizing molecules, which are already bonded to a support material. The solvent used to make the inventive compositions may be an organic solvent, water or a combination thereof. Organic solvents that can be used include alcohols, ethers, glycols, ketones, aldehydes, nitrites, and the like.

Preferred solvents are liquids with sufficient polarity to dissolve metal salts. These preferred solvents include water, methanol, ethanol, n-propanol, isopropyl alcohol, acetonitrile, acetone, tetrahydrofuran, ethylene glycol, dimethylformamide, dimethylsulfoxide, methylene chloride, and the like, including mixtures thereof.

Other chemical modifiers may also be included in the liquid mixture. For example, acids or bases may be added to adjust the pH of the mixture. Surfactants may be added to adjust the surface tension of the mixture, or to stabilize the nanoparticles.

The solvent for the nanoparticle components may be a neat solvent, but it is preferable to use an acidic solution, as acids aid in the dissolution of the nanoparticle components. The solution may be acidified with any suitable acid, including organic and inorganic acids. Preferred acids are mineral acids such as sulfuiric, phosphoric, hydrochloric, and the like, or combinations thereof. While it is possible to use an acid in a wide range of concentrations, it is generally only necessary to use relatively dilute solutions to accomplish a desired solubility enhancement.

III. Methods of Making Supported Nanocatalysts

Preferred methods for manufacturing supported nanocatalysts according to the invention can be broadly summarized as follows. First, one or more types of catalyst atoms and one or more types of functionalized supports are selected. Second, the catalyst atoms (e.g., metals or other components) and the functionalized support are reacted or combined together to form catalyst complexes between the catalyst atoms and the functionalizing molecules on the support material. Third, the catalyst complexes are allowed to form catalyst nanoparticles or are further treated to form catalyst nanoparticles.

A. Providing Functionalized Support

In an exemplary embodiment, the functionalized support is manufactured by selecting a support material and a functionalizing agent and then reacting them together. The support material and functionalizing agent are selected for their ability to bond to one another, yet leave at least one available functional group per functionalizing molecule for subsequent bonding to the catalyst atoms.

Various optional treatments can be performed to improve bonding between the support material and the functionalizing agent. For example, the support material can be pre-treated with an alcohol or an acid. Examples of suitable alcohols include methanol, ethanol, isopropanol, butanol, and the like. Suitable acids include sulfuric acid, nitric acid, and phosphoric acid. Excess treating agent is typically removed before reacting the support material with the functionalizing agent.

The functionalizing agent and the support material are typically reacted together in the presence of a solvent or carrier. The same solvents or carriers used to make the catalyst nanoparticles can also be useful for reacting the support material with the functionalizing agent. After reacting the support and functionalizing agent, the solvent and/or excess functionalizing agent can be removed by washing and/or drying. The functionalized support can also be subjected to an optional calcining step to remove unwanted materials.

In addition to designing and manufacturing a functionalized support as described above, the methods of the present invention can also be carried out using commercially available functionalized support materials. Any solid functionalized support having functional groups as described above can be used in the present invention, so long as the functionalized support includes functional groups available for bonding with the catalyst atoms. For example, the manufacture of supported nanocatalysts according to the present invention can be carried out using one or more of the many known functionalized silica gels (e.g., functionalized with acid groups or amines bonded to the silica via a silane linkage), which are commercially available. Those skilled in the art are familiar with the many different types of functionalized materials that are available.

B. Formation of Nanocatalyst Particles

Nanocatalyst particles are generally formed by complexing one or more types of catalyst atoms with one or more available functional groups of a functionalized support. This reaction is typically carried out in the presence of an appropriate solvent or carrier. In one embodiment, the available functional groups facilitate the formation- of nanoparticles as the complexed or bonded catalyst atoms are treated in one or more subsequent steps (e.g., heat treatment, reduction, and the like). In another version of the invention, the nanoparticles form as the catalyst atoms react with the available functional groups without subsequent treatment.

The catalyst atoms can be provided in any form so as to be soluble or dispersible in the solvent or carrier. For example, catalyst atoms can be provided as metal salts that are readily dissolvable in the solvent or carrier. It may also be advantageous to use metal chlorides and nitrates, since metal chlorides and nitrates are typically more soluble than other metal salts. Catalyst atoms can be added to the solvent or carrier singly or in combination to provide final nanoparticles that comprise mixtures of various types of catalyst atoms.

Whereas the inventive methods for manufacturing supported nanocatalysts include forming a functionalized support prior to reacting or complexing the support with catalyst atoms, it is not always necessary to form the functionalized support in advance of mixing with the catalyst atoms. For example, in the case where catalyst atoms, a support material, and a functionalizing agent are mixed together at the same time, at least a portion of the functionalizing agent may bond to the support material so as to yield a functionalized support prior to reacting with the catalyst atoms. Accordingly, this represents a manufacturing sequence within the scope of the invention for manufacturing supported nanocatalysts.

IV. Supported Nanocatalysts

Preferred supported nanocatalysts according to the invention include well-dispersed catalytic nanoparticles anchored to an appropriate support material. The functionalizing agent acts as an anchor when bonded to both the support material and catalyst atoms in the nanocatalyst particles. The supported nanocatalysts may include a single type of catalyst metal or component, or they may be multicomponent catalysts.

Metal loadings of the nanocatalyst particles on the support material can vary depending on the intended use of the supported nanocatalyst. In a preferred embodiment, the metal loading is between about 0.01% and about 10% by weight, and more preferably between about 0.05% and about 5% by weight. Catalysts with these loading amounts are useful in carbon-carbon coupling reactions (e.g., Heck and Suzuki reactions).

In a preferred embodiment, the methods of making supported nanocatalysts according to the present invention produce finely dispersed nanoparticles. In a preferred embodiment, the nanoparticles have an diameter less than about 100 nm, more preferably less than about 20 nm, even more preferably less than about 6 nm, and most preferably less than about 4 nm.

The nanoparticles of the present invention can be made to have a desired crystal face exposure. In one embodiment, the crystal face exposure is controlled by selecting particular functionalizing molecules. For example, it is currently believed that supports functionalized with polymers, especially unbranched (linear) polymers, tend to produce nanoparticles of palladium, platinum and other metals with similar face-centered cubic crystal structures with a selective exposure of the 110 crystal face, while small organic molecules or branched polymers tend to produce nanoparticles of the same metals that selectively expose the 111 crystal face.

As illustrated in the examples provided herein, the supported nanocatalyst particles manufactured according to the present invention have novel properties as compared to catalysts manufactured using other techniques. Because of the nature of the nanocatalyst particles, it is not always possible to identify the particular feature of the nanoparticle that produces the new and desired property. The inventors currently believe that the novel supported nanocatalysts of the present invention have improved crystal arrangements, sizes, and or particle configurations that give the nanocatalyst particles their improved properties. These novel properties are likely produced by having the functionalizing molecules pre-bonded to the support surface during nanoparticle formation and/or by influencing the arrangement or bonding of the nanoparticles to the support surface.

V. Methods of Performing Heck and Suzuki Carbon-Carbon Couplings

Supported nanocatalysts made using the methods of the present invention are particularly useful for performing carbon-carbon couplings in the Heck and Suzuki reactions. In particular, palladium based catalysts are especially useful for performing carbon-carbon couplings. It should be understood, however, that supported and anchored nanocatalysts manufactured by other methods developed by the inventors may be useful in carrying out Heck and Suzuki coupling reactions. Examples of supported and anchored nanocatalysts are described in U.S. Pat. No. 6,746,597, the disclosure of which is incorporated herein by reference. It has been found, however, that superior results may be obtained when using, supported catalysts manufactured using the inventive methods of the present application to carry out Heck or Suzuki reactions.

The Heck coupling reaction typically includes reacting an aryl halide or a vinyl halide with an alkene in the presence of a palladium catalyst and a base. The Suzuki coupling reaction typically includes reacting organoboronic acids with alkenyl or aryl halides.

Nanocatalysts manufactured according to the present invention have shown increased catalytic activity for performing Heck and Suzuki coupling reactions as compared with other catalysts.

In Examples 2-4 below, supported palladium based nanocatalysts were used in a Heck reaction to catalyze the carbon-carbon coupling of 2-bromo-6-methoxynapthalene with n-butyl vinylether. The reaction was carried out according to the following equation:

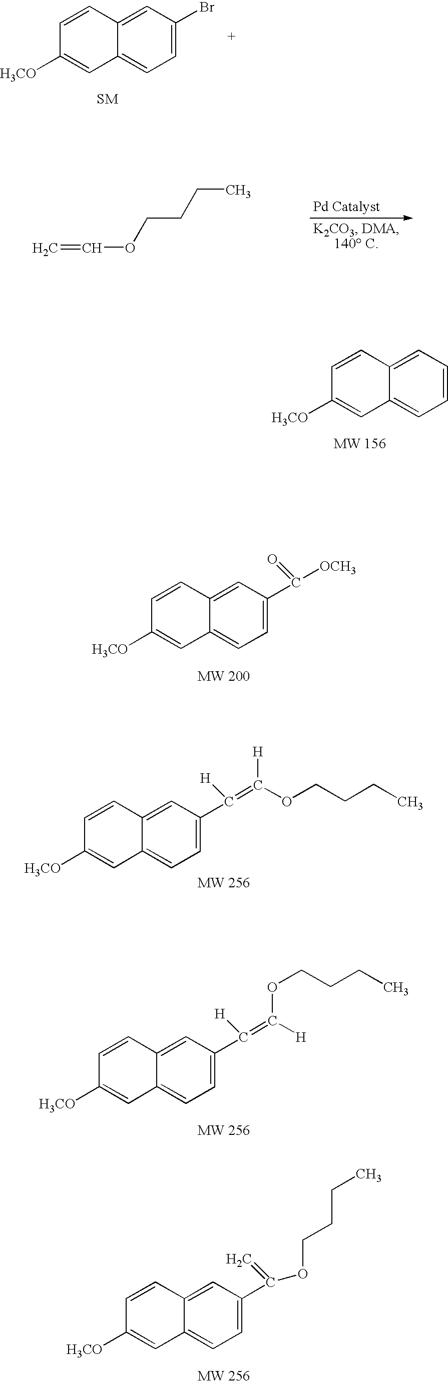

### EXAMPLE 1

### Comparative Homogenous Catalyst

For comparative purposes, the foregoing Heck reaction was carried out using a homogeneous PdCl₂ catalyst prepared according to methods that are well-known in the art.

### EXAMPLE 2

### Supported Palladium Nanocatalyst Formed Using Other Method

For comparative purposes, both with respect to homogeneous catalysts and supported nanocatalysts made according to the inventive methods, a supported palladium nanocatalyst was prepared for use in the Heck reaction. The comparative supported nanocatalyst was prepared by reacting a plurality of palladium catalyst atoms with polyacrylic acid to form a colloidal solution. More specifically, an acidic solution of PdCl₂ (0.6665 g PdCl₂ in 500 ml water) and a solution of polyacrylic acid (10.13 g of 45% of polyacrylic acid solution in 100 ml of water) were added to a three neck.flask and purged with nitrogen for 2 hours. The mixture was then purged with hydrogen for 45 minutes and stirred overnight.

The suspension was then mixed with an alumina-silica support to form catalyst nanoparticles and to anchor the catalyst nanoparticles to the support. More specifically, a glass reactor containing 10 g of Al₂O₃—SiO₂ was submitted to 5 cycles of evacuation and refilling with argon over a period of 30 minutes. The support was soaked in methanol (50 ml) for 2 hours followed by decantation of the solvent and addition of the colloid solution previously prepared. The contents were stirred using a suspended stirrer while heat was applied to evaporate the water. Complete evaporation was followed by a calcination step at 30° C. for 6 hours under hydrogen. Washing of the support with water until no free chlorine was detected and drying the support for 3 hours at 100° C. were the final steps of the preparation.

Palladium loading on the support was 4% by weight. The supported palladium nanocatalyst was used to carry out the Heck reaction outlined above.

### EXAMPLE 3

### 4% Pd on Al₂O₂—SiO₂ Support

A palladium catalyst was prepared according to the inventive methods of the present application. More particularly, a glass reactor containing 10 g of Al₂O₃—SiO₂ was submitted to 5 cycles of evacuation and refilled with argon over a period of 30 minutes. The support was soaked in methanol (50 ml) for two hours followed by decantation of the solvent and addition of a solution containing the anchoring agent (10.13 g of 45% polyacrylic acid sodium salt in 250 ml of water). The contents were stirred using a suspended stir while heat was applied to evaporate the water. After complete evaporation, the modified support was placed in the oven for 4 hours at 80° C.

The modified support was then washed with water and dried at 100° C. for 3 hours to yield the functionalized support. Thereafter, the functionalized support was mixed with an acidic solution of palladium chloride (0.6665 g PdCl₂ in 500 ml of water). Complete evaporation of the solvent was followed by a calcination step at 300 ° C for 6 hours under hydrogen. Washing of the support with water until no free chlorine was detected and drying the support for 3 hours at 100° C. were the final steps of the preparation.

Palladium loading was 4%. The palladium nanocatalyst of Example 3 was used in the Heck reaction to catalyze carbon-carbon coupling of 2-bromo-6-methoxynapthalene with n-butyl vinylether.

### EXAMPLE 4

### 4% Pd on SiO₂ Support

A supported nanocatalyst according to the present invention was prepared using the same steps as in Example 3, except that the support material was SiO₂. This nanocatalyst was then used to catalyze carbon-carbon coupling of 2-bromo-6-methoxynapthalene with n-butyl vinylether in a Heck reaction.

The results of the Heck reaction performed using the catalysts of Examples 1-4 are shown in Table I below and according to the following procedure. A glass reactor containing 0.0266 g supported catalyst (0.01 mmol Pd) and K₂CO₃ (1.047 g, 7.5 mmoles) was placed under vacuum for 15 minutes during which 5 cycles of evacuation and refilling with argon were performed. A solution of 2-bromo-6-methoxy-naphthalene (1.22 g, 5 mmoles) in 13.5 ml of dimethylacetamide was added to the reaction flask followed by the addition of 1.5 ml of n-butylvinylether (10 mmoles). The system was purged with argon and then placed in a stir/hot plate at 140° C. An aliquot was taken every hour to monitor the progress of the reaction. Upon completion, the supported catalyst was removed by filtration and the product analyzed by atomic absorption.

TABLE I

| | | Time | Starting | | | | | Metal |
|---|---|---|---|---|---|---|---|---|
| | Catalyst | hrs | Material | MW256 | MW256 | MW256 | % Conv | leaching |
| Example 1 | PdCl₂ | 21 | 71.5 | 13.5 | 5.0 | 9.9 | 28.5% | N/A |
| | Comparative | | | | | | | |
| | Homogeneous | | | | | | | |
| | Catalyst | | | | | | | |
| Example 2 | 4% Pd/Al₂O₃—SiO₂ | 24 | 58.1 | 19.2 | 6.6 | 16.0 | 41.9% | |
| | Comparative | | | | | | | |
| | Supported | | | | | | | |
| | Nanocatalyst | | | | | | | |
| Example 3 | 4% Pd/Al₂O₃—SiO₂ | 24 | 16.2 | 37.9 | 16.7 | 29.2 | 83.8% | |
| | Supported | | | | | | | |
| | Nanocatalyst | | | | | | | |
| Example 4 | 4% Pd/SiO₂ | 20 | 10.7 | 39.1 | 18.0 | 32.1 | 89.3% | <0.1 ppm |
| | Supported | | | | | | | |
| | Nanocatalyst | | | | | | | |

As plainly shown by the data set forth in Table I, the supported nanocatalysts of Examples 2-4 were far more effective than the homogeneous catalyst of Example 1 in forming the desired MW256 isomers. That indicates that supported palladium nanocatalysts, in general, regardless of how they are manufactured, are superior to homogeneous catalysts in carrying out Heck-carbon coupling reactions. This is a surprising and unexpected result.

Moreover, the supported nanocatalysts of Examples 3 and 4 manufactured according to the inventive methods disclosed herein exhibited far better results than supported nanocatalysts formed in another way, as in Example 2. This is also a surprising and unexpected result.

### EXAMPLES 5-8

### Suzuki Coupling

In Examples 5-8, the catalysts of Examples 1-4, respectively, where used to catalyze the carbon-carbon coupling of phenyl bromide with phenylboronic acid using the Suzuki method. The reaction was carried out according to the following equation:

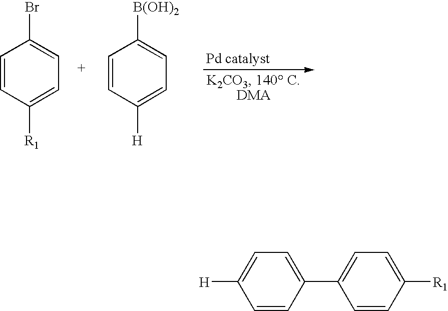

The reaction was carried out according to the following procedure. A glass reactor containing 0.0266 g supported catalyst (0.01 mmol Pd) and K₂CO₃ (1.047. g, 7.5 mmoles) was placed under vacuum for 15 minutes during which 5 cycles of evacuation and refilling with argon were performed. After the addition of DMA (dimethylacetamide, 14.5 ml), bromobenzene (0.5 ml, 5 mmoles) and phenylboronic acid (1.6 g, 12.5 mmoles), the system was purged with argon and then placed in a stir/hot plate at 140° C. An aliquot was taken every hour to monitor the progress of the reaction. Upon completion, the supported catalyst was removed by filtration and the product analyzed by atomic absorption.

The results of Examples 5-8 in carrying out the Suzuki coupling reaction are shown in Table II below.

TABLE II

| | | Time | Starting | | | Metal |
|---|---|---|---|---|---|---|
| | Catalyst | Hrs | material | Product | % Conv | Leaching |
| Example 5 | PdCl₂ | 1 | 11.4 | 88.6 | 88.6% | N/A |
| | Comparative | | | | | |
| | Homogeneous | 2 | No further | | | |
| | Catalyst | | rxn | | | |
| Example 6 | 4% Pd/Al₂O₃—SiO₂ | 1 | 43.5 | 56.5 | 94.7% | <0.6 ppm |
| | Comparative | 2 | 23.3 | 76.7 | | |
| | Supported | 3 | 16.4 | 83.6 | | |
| | Nanocatalyst | 5 | 7.5 | 92.5 | | |
| Example 7 | 4% Pd/Al₂O₃—SiO₂ | 1 | 16.5 | 83.5 | 93.2% | <0.1 ppm |
| | Supported | 2 | 10.7 | 89.3 | | |
| | Nanocatalyst | 3 | 8.4 | 91.6 | | |
| | | 5 | 8.2 | 91.8 | | |
| Example 8 | 4% Pd/SiO₂ | 1 | 0 | 100% | 100% | <0.1 ppm |
| | Supported | | | | | |
| | Nanocatalyst | | | | | |

The results of Examples 5-8 show a similar trend when carrying out the Suzuki reaction. The supported nanocatalysts used in Examples 6-8 resulted in significantly higher yields compared to the homogeneous catalyst of Example 5. Moreover, the supported nanocatalysts of Examples 7 and 8 manufactured according to the inventive methods disclosed herein resulted in significantly higher formation of product per hour and/or yield depending on the support used than the supported nanocatalyst of Example 6.

In general, the foregoing examples for performing Heck and Suzuki coupling reactions illustrate the novel properties of supported nanocatalysts, particularly those prepared according to the methods of the present invention. Nanocatalysts prepared according to the methods of the present invention showed higher conversion rates for Heck and Suzuki reactions as compared with catalysts prepared using other methods. Even in comparison to methods that use a functionalizing agent to form and anchor the nanocatalyst particles, higher conversion rates where observed for particles formed according to the inventive methods disclosed herein (i.e., in which the functional groups are bonded to the support before being reacted with the catalyst atoms). In addition, the supported nanocatalysts made according to the methods of the present invention are longer lasting as evidenced by their very low leaching rates. On the other hand, the anchored nanocatalyst used in Examples 2 and 6, though inferior to the anchored nanocatalysts used in Examples 3, 4, 7 and 8, was nevertheless superior compared to the homogeneous catalyst used in Examples 1 and 5.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a supported nanocatalyst, comprising:
(a) providing a support material;
(b) providing a functionalizing agent comprising a plurality of functionalizing agent molecules, each having at least two functional groups; at least one functional group for bonding the functionalizing agent molecules to the support material and at least one other functional group for bonding to one or more catalyst atoms;
(c) reacting the functionalizing agent with the support material in order to bond the functionalizing agent to the support material and thereby yield a functionalized support having available functional groups; and
(d) reacting a plurality of catalyst atoms with the available functional groups of the functionalized support to form a plurality of nanocatalyst particles that are anchored to the support material.

2. A method of manufacturing a supported nanocatalyst as in claim 1, wherein the support material comprises at least one material selected from the group consisting of metals, metal oxides, nonmetals, and polymers.

3. A method of manufacturing a supported nanocatalyst as in claim 1, wherein the support material comprises at least one member selected from the group consisting of alumina, silica, silica gel, titania, kieselguhr, diatomaceous earth, bentonite, clay, zirconia, magnesia, zeolites, carbon black, activated carbon, graphite, and fluoridated carbon.

4. A method of manufacturing a supported nanocatalyst as in claim 1, wherein the catalyst atoms comprise at least one noble metal.

5. A method of manufacturing a supported nanocatalyst as in claim 1, wherein the at least one functional group for bonding to one or more catalyst atoms comprises at least one member selected from the group consisting of a carboxylic acid, a carbonyl, a hydroxyl, a thiol, an amine, an amide, a sulfonic acid, a sulfonyl halide, an acyl halide, a nitrile, and a nitrogen with a free lone pair of electrons.

6. A method of manufacturing a supported nanocatalyst as in claim 1, wherein the at least one functional group for bonding the functionalizing agent molecules to the support material comprises at least one member selected from the group consisting of a carboxylic acid, a carbonyl, a hydroxyl, a thiol, an amine, an amide, a sulfonic acid, a sulfonyl halide, an acyl halide, a nitrile, a silane, and a nitrogen with a free lone pair of electrons.

7. A method of manufacturing a supported nanocatalyst as in claim 1, wherein the functionalizing agent is selected from the group consisting of diacids, polyacids, polymeric acids, hydroxy acids, hydroxy acyl halides, carboxy acyl halides, diacyl halides, and combinations thereof.

8. A method of manufacturing a supported nanocatalyst as in claim 1, wherein the functionalizing agent comprise at least one type of polymer or oligomer.

9. A method of manufacturing a supported nanocatalyst as in claim 1, wherein the functionalizing agent is covalently bonded to the support material.

10. A method of manufacturing a supported nanocatalyst as in claim 1, wherein (c) and (d) are carried out by (i) mixing together the support material, functionalizing agent, and catalyst atoms in a single step, (ii) allowing at least some of the functionalizing agent molecules to react with the support material to yield the functionalized support, and (iii) reacting the functionalized support made in (ii) with the catalyst atoms.

11. A supported nanocatalyst manufactured according to the method of claim 1.

12. A supported nanocatalyst as in claim 11, wherein the nanocatalyst particles comprise palladium.

13. A method for performing a Heck coupling reaction, comprising reacting at least one of an alkyl compound or an aryl compound with a vinyl compound in the presence of the supported nanocatalyst of claim 12 to form a carbon-carbon bond.

14. A method for performing a Heck coupling reaction as in claim 13, wherein an aryl halide is reacted with the vinyl compound.

15. A method for performing a Heck coupling reaction as in claim 13, wherein a majority of catalyst atoms on a surface of the nanocatalyst particles have a nearest neighbor coordination number of 2 and preferentially promote formation of linear rather than branched reaction product isomers.

16. A method for performing a Suzuki coupling reaction, comprising reacting at least one of an alkenyl compound or an aryl compound with an organoboronic acid in the present of the supported nanocatalyst of claim 12 so as -to form a carbon-carbon bond.

17. A method for performing a Suzuki coupling reaction as in claim 15, wherein an aryl halide is reacted with phenylboronic acid.

18. A method for performing a Suzuki coupling reaction as in claim 15, wherein a majority of catalyst atoms on a surface of the nanocatalyst particles have a nearest neighbor coordination number of 2 and preferentially promote formation of linear rather than branched reaction product isomers.

19. A method of manufacturing a supported nanocatalyst on a solid support material, comprising:
(a) providing a functionalized support comprising a solid support material and a functionalizing agent bonded thereto, the functionalizing agent comprising individual molecules having at least one functional group available for bonding with catalyst atoms; and
(b) reacting a plurality of catalyst atoms with the functionalized support to form a plurality of nanocatalyst particles anchored to the support material.

20. A method of manufacturing a supported nanocatalyst as in claim 19, wherein the solid support material comprises at least one of a polymeric material or an inorganic material.

21. A method of manufacturing a supported nanocatalyst as in claim 19, wherein the support material comprises at least one of alumina, silica, silica gel, titania, kieselguhr, diatomaceous earth, bentonite, clay, zirconia, magnesia, or zeolite.

22. A method of manufacturing a supported nanocatalyst as in claim 19, wherein (b) is carried out in a solvent and the catalyst atoms are provided as a metal salt.

23. A method of manufacturing a supported nanocatalyst as in claim 19, wherein the functional group comprises at least one member selected from the group consisting of a carboxylic acid, a carbonyl, a bydroxyl, a thiol, an amine, amide, a sulfonic acid, a sulfonyl halide, an aryl halide, a nitrile, a nitrogen with a free lone pair of electrons.

24. A supported nanocatalyst manufactured according to the method of claim 19.

25. A supported nanocatalyst as in claim 24, wherein the nanocatalyst particles comprise palladium.

26. A method for performing a Heck coupling reaction, comprising reacting at least one of an alkyl compound or an aryl compound with a vinyl compound in the presence of the supported nanocatalyst of claim 25 to form a carbon-carbon bond.

27. A method for performing a Suzuki reaction, comprising reacting at least one of an alkenyl compound or an aryl compound with an organoboronic acid in the presence of the supported nanocatalyst of claim 25 so as to form a carbon-carbon bond.

28. A method of manufacturing supported nanocatalyst, comprising:
(a) providing a solid support material;
(b) providing a functionalizing agent comprising a plurality of functionalizing agent molecules, each comprising:
(i) at least one functional group for bonding to one or more catalyst atoms comprising at least one member selected from the group consisting of a carboxylic acid, a carbonyl, a hydroxyl, a thiol, an amine, an amide, a sulfonic acid, a sulfonyl halide, an acyl halide, a nitrile, and a nitrogen with a free lone pair of electrons; and
(ii) at least one other fictional group for bonding the functionalizing agent molecules to the support material comprising at least one member selected from the group consisting of a carboxylic acid, a carbonyl, a hydroxyl, a thiol, an amine, an amide, a sulfonic acid, a sulfonyl halide, an acyl halide, a nitrile, a silane, and a nitrogen with a free lone pair of electrons.
(c) reacting the functionalizing agent with the solid support material to yield a functionalized support; and
(d) reacting a plurality of catalyst atoms with the functionalized support in the presence of a solvent to form a plurality of catalyst nanoparticles

29. A method as in claim 28, wherein the solvent comprises at least one of water or a monofunctional alcohol and the catalyst atoms are provided as a metal salt.

30. A method for performing a Heck or Suzuki carbon-carbon coupling reaction, comprising
(a) providing a supported nanocatalyst comprising a plurality of nanocatalyst particles anchored to a solid support-material by one or more types of anchoring molecules; and
(b) performing a Heck or Suzuki carbon-carbon coupling reaction in the presence of the supported nanocatalyst.
